(19) United States
(12) Patent Application Publication
(10) Pub. No.: US 2003/0063043 A1
(43) Pub. Date: Apr. 3, 2003

(54) Method and apparatus for wireless headset video interface

(76) Inventor: Luke E. Girard, Santa Clara, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/002,332

(22) Filed: Nov. 14, 2001

Related U.S. Application Data
(63) Continuation-in-part of application No. 09/968,108, filed on Sep. 28, 2001.

(51) Int. Cl. G09G 5/00

(52) U.S. Cl. 345/8

(57) ABSTRACT

A computing system including a remote thin client and a server are disclosed. The server transmits a display command to the remote thin client. The remote thin client displays an image according to the display command.

### REFERENCE TO RELATED APPLICATION

This is a continuation-in-part of application Ser. No. 09/968,108 filed Sep. 28, 2001.

### FIELD OF THE INVENTION

The present invention relates to the areas headsets and video interfaces. Specifically, the present invention relates to a wireless headset video interface.

### BACKGROUND

Thin clients are well known in the art. Thin clients are popular because they contain little hardware and thus are light. Because the thin client has little hardware, it relies on the computing capability of the server. The thin client is typically coupled to the server, for example, a personal computer, through a wired connection.

Wireless technology can add to the convenience of using a thin client. Presently, the application of wireless technology to the thin client is centered around providing features such as wireless synchronizing, voice connections and data communications. Additional features of the wireless technology can be applied to the thin client to increase the convenience of using the thin client.

### BRIEF DESCRIPTION OF THE DRAWINGS

The present invention is illustrated by way of example and not limitation in the figure of the accompany drawing, in which:

FIG. 1 illustrates an exemplary embodiment of the computing system; and

FIG. 2 illustrates one embodiment of the flow diagram of the method to transmit a video frame.

### DETAILED DESCRIPTION

A remote thin client video interface is disclosed. In one embodiment, the thin client can include a headset including a mini color monocular display for private viewing. In another embodiment, the thin client can include the display of a notebook computer. In one embodiment, the server can include a personal computer. In another embodiment, the server can include a Bluetooth enabled mobile telephone. In another embodiment, the server can include a wireless MP3 player. In yet another embodiment, the server can include a wearable computer. The thin client includes a low power computing capability and is coupled to a server through a wireless link.

A thin client is known in the art as a simple client machine that performs very little processing. In this client/server arrangement, most of the application processing is done in the (fat) server. For example, a thin client may supply only the graphical interface. The advantage of a thin client is simpler hardware and simpler maintenance. The maintenance for applications is done on the server. A few examples of the thin clients include the Gopher clients, the X clients used on many Unix systems, and the NTRIGUE clients that communicate with a Windows server through the Windows NT version 4 operating system.

The headset includes just enough computing capability, memory, and resources to render graphics commands received from the personal computer. The personal computer transmits graphic commands to the headset. The graphic commands can include the X protocol graphic command and the compressed delta bitmap graphic command. The headset renders the graphic commands into the pixels that the user can view on the monocular display. The headset can include a computing system implemented in the form of an Application Specific Integrated Circuit (ASIC) to decompress the video.

A video clip can also be streamed from the personal computer to the headset by using a compression protocol. In one embodiment, the compression protocol can include a Motion Pictures Expert Group (MGEP) standard compatible protocol. The MPEG standard 2 (MPEG-2) compression protocol can compress a two-hour video into a few gigabytes. The MPEG-4 compression protocol is designed to transmit video and images over a narrow bandwidth and can compress color images at rates of 20:1 up to 300:1 and grayscale images at 20:1 to 50:1. In another embodiment, the compression protocol can include the Joint Photographic Experts Group (JPEG) compression technique. The JPEG technique can reduce the bitmap file for a color image to about five percent of its normal size.

In one embodiment, the wireless link includes a Bluetooth protocol enabled link. Specifically, the wireless link includes a Bluetooth 1.0 specification compatible link. The thin client can communicate with the server within a thirty-five foot range. A line-of-sight connection between the client and the server is not needed. To facilitate the Bluetooth link, Bluetooth Integrated Circuit (IC) chips are embedded in the client and the server. The Bluetooth IC chip is a tiny chip measuring 9×9 millimeters. In another embodiment, the wireless link includes an infrared link.

The thin client of the present invention can also include a boom or ear microphone and an audio connectivity to the server. In one embodiment, the ear microphone and the audio connectivity can be used for command and control. In another embodiment, the ear microphone and the audio connectivity can be used to make and receive telephone calls. In yet another embodiment, the audio connectivity can be used to receive audio prompts from the computer. In still another embodiment, the audio connectivity can be used to listen to music from a MP3 player.

The present invention combines the thin client technology and the wireless technology to provide a thin client video interface. The present invention further uses encryption and compression algorithms to reduce the required communication bandwidth for the wireless link.

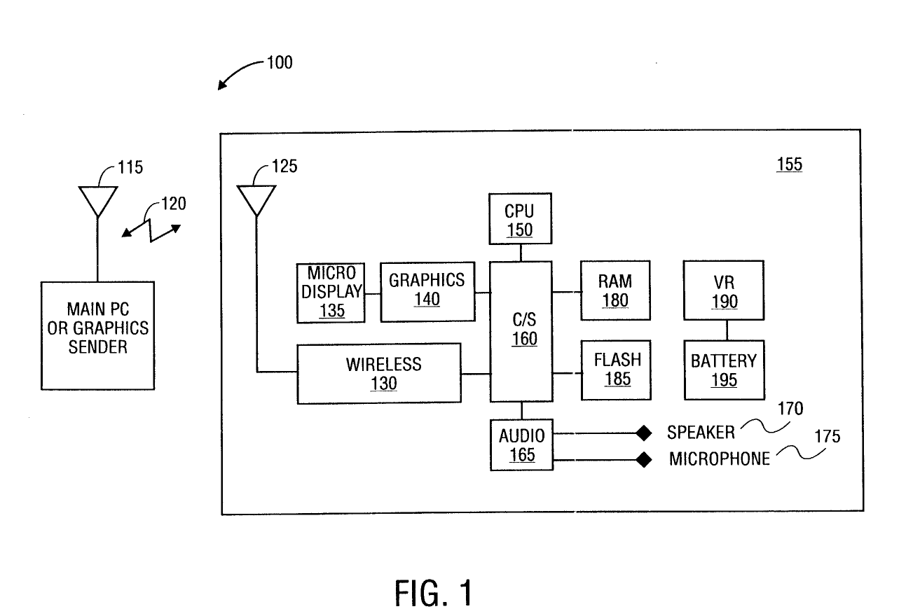

FIG. 1 illustrates an exemplary embodiment of the computing system of the present invention. The computing system 100 is shown including the server 110 coupled to the thin client 155 through the wireless link 120.

In one embodiment, the server 110 includes a notebook computer. In another embodiment, the server 110 includes a World Wide Web server. In yet another embodiment, the server 110 includes a multimedia server. The server 110 transmits a video clip comprising a plurality of video frames to the thin client 155. In one embodiment, the server 110 transmits bitmap files of the video frame. In another embodiment, the server 110 transmits the bitmap file only for the first video frame of the plurality of video frames of the video clip. The server 110 transmits display commands to change the first video frame into further video frames. The thin client 155 processes the display commands and renders the images of the video frames. Transmitting display commands instead of bitmap files reduces the required transmission bandwidth. In yet another embodiment, to reduce the transmission bandwidth, the server 110 can compress the bitmap file for a video frame before its transmission.

In this description, in one embodiment, the term video frame refers to a proprietary video frame. In another embodiment, the term video frame refers to a standard video frame. In yet another embodiment, the term video frame refers to a portion of a video stream.

The server 110 includes the antenna 115 to transmit the video clip to the client 155 through the wireless link 120. In one embodiment, the wireless link 120 includes a Bluetooth link. In another embodiment, the wireless link 120 includes an infrared link. In still another embodiment, the wireless link 120 includes an Institute of Electrical and Electronics Engineers (IEEE) wireless Local Area Network (LAN) 802.11 protocol compatible link.

In one embodiment, the Bluetooth 802.11(a) compatible link 120 includes a 54 megabits per second capacity link. In another embodiment, the Bluetooth 802.11(b) link 120 includes a 11 megabits per second capacity link. In yet another embodiment, the Bluetooth 802.11(b) link 120 includes a 22 megabits per second capacity link.

In one embodiment, the remote thin client 155 includes the chipset 160 coupled to the processor 150, the random access memory (RAM) 180, the flash memory 185, the audio system 165, the graphics system 140 coupled to the display 135, and the wireless component 130 coupled to the antenna 125. The antenna 125 can include an emitter or a diode. In another embodiment, the remote thin client 155 does not include the audio system. In another embodiment, the thin client 155 also includes the battery 195 coupled to the voltage regulator 190. The thin client 155 is a low power consumption computing system that can be implemented as an Application Specific Integrated Circuit (ASIC) chip.

The processor 150 can include very low power consumption processors. In one embodiment, the processor 150 can include a Strong Advanced RISC Machine (ARM) processor also manufactured by the Intel Corporation. In another embodiment, the processor 150 can include a uScale processor also manufactured by the Intel Corporation.

In one embodiment, the wireless component 130 includes a codec unit including a coder and a decoder. In other embodiments, the wireless component 130 can includes encryption and decryption modules.

The RAM 180 can include a memory buffer to store the bit map file received from the server 110 from which the video frame image is rendered. In one embodiment, the memory buffer includes a one megabyte buffer. In other embodiments, the memory buffer includes a two, four or sixteen megabytes bytes buffer. The flash memory 185 can store instructions to boot up the thin client 155. The graphics module 140 renders the video frame image on the display 135. In one embodiment, the graphics module 140 renders the image by processing the bitmap file stored in the RAM 180. In another embodiment, the processor 150 and the graphics module 140 render the image by processing the display commands received from the server 110.

In one embodiment, the display 135 can include a monocular display mounted on a headset. In another embodiment, the display 135 can include an interactive graphical display interface.

The audio system 165 includes the speaker 170 and the microphone 175. The speaker 170 can be used to listen to the audio signals received from the server 110, for example, music received from a MP3 player. The microphone 175 can be used to speak during a telephone conversation through the server 110, for example, conversation through a Bluetooth enabled wireless telephone. The microphone can also be used to record audio signals on the server 110 and to perform voice recognition through the server 110. The audio system 165 can render compressed audio locally.

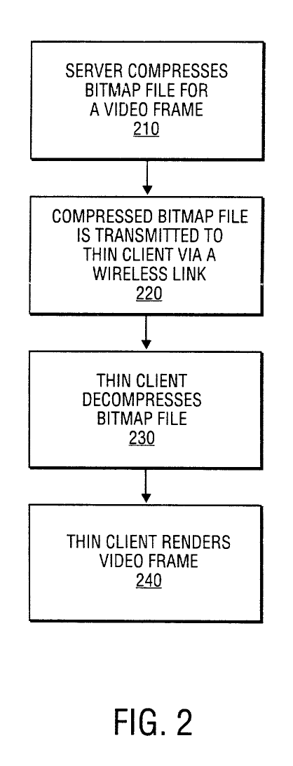

FIG. 2 illustrates one embodiment of the flow diagram of the method to transmit a video frame. At block 210, a server compresses a bitmap file for a video frame. At block 220, the compressed bitmap file is transmitted to the thin client via a wireless link. At block 230, the thin client decompresses the bitmap file. At block 240, the thin client renders the video frame.

These and other embodiments of the present invention may be realized in accordance with these teachings and it should be evident that various modifications and changes may be made in these teachings without departing from the broader spirit and scope of the invention. The specification and drawings are, accordingly, to be regarded in an illustrative rather than restrictive sense and the invention measured only in terms of the claims.

In addition, the instructions to perform the methods as described above could alternatively be stored on other forms of computer-readable mediums. A machine-readable medium includes any mechanism that provides (e.g., stores and/or transmits) information in a form readable by a machine (e.g., a computer). A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

What is claimed is:

1. A headset comprising:
a receiver to receive a display command through a wireless link; and
a processor coupled to render an image according to the display command.

2. The headset of claim 1, wherein the headset includes a monocular display to display the image.

3. The headset of claim 2, wherein the headset receives the display command from a server to change an image displayed on the monocular display.

4. The headset claim 1, wherein the receiver receives a compressed display command.

5. The headset of claim 4, wherein the processor decompresses the compressed display command.

6. The headset of claim 5, wherein the processor decompresses the bitmap file in accordance with a Motion Pictures Experts Group (MPEG) protocol.

7. The headset of claim 1, wherein the wireless link includes a Bluetooth enabled link.

8. A computer-readable medium having stored thereon a set of instructions to translate instructions, the set of instructions, which when executed by a processor, cause the processor to perform a method comprising:
a headset receiver receiving a compressed display command through a wireless link; and
a headset processor decompressing the compressed display command, and displaying an image according to the display command.

10. The medium of claim 8, including a headset mounted monocular display displaying the image.

11. The medium of claim 8, including the headset receiver receiving a compressed bitmap file for the display command.

12. The medium of claim 11, including the headset processor decompressing the compressed bitmap file in accordance with a Motion Pictures Experts Group (MPEG) protocol.

13. A method comprising:
a headset receiver receiving a compressed display command through a wireless link; and
a headset processor decompressing the compressed display command, and displaying an image according to the display command.

14. The method of claim 13, including a headset mounted monocular display displaying the image.

15. The method of claim 13, including the headset receiver receiving a compressed bitmap file for the display command.

16. The method of claim 15, including the headset processor decompressing the compressed bitmap file in accordance with a Motion Pictures Experts Group (MPEG) protocol.
